(19) United States
(12) Patent Application Publication
(10) Pub. No.: US 2011/0320515 A1
(43) Pub. Date: Dec. 29, 2011

(54) Medical Imaging System

(76) Inventor: Zahiruddin Mohammed, Bangalore (IN)

(21) Appl. No.: 12/823,188

(22) Filed: Jun. 25, 2010

(51) Int. Cl. G06F 15/16

(52) U.S. Cl. 709/201

(57) ABSTRACT

A medical imaging system, a computer program product and method of processing a medical image, wherein the medical imaging system comprises a first module and a second module for processing the medical image, the first module being operably connected to the second module and wherein, the first module being configured to provide the medical image to the second module for processing and the second module being configured to provide to the first module an information indicative of a processing status of the medical image using DICOM communication protocols.

### FIELD OF INVENTION

The embodiments herein generally relate to radiography imaging systems, and, more particularly, to an integrated system for medical use.

### BACKGROUND OF INVENTION

Modern medical imaging systems include a number of components such as scanners, servers, workstations, printers, and network hardware. The devices are used for handling, storing, printing and transmitting of medical images of the human body and associated information such as patient data. The scanners can include, input imaging modalities such as a magnetic resonance (MR), computer tomography (CT), digital radiography and ultrasound devices. These devices manufactured by different manufacturers produce a variety of digital image formats. This introduces obstacles in interoperability between components manufactured by different manufacturers.

To promote the communication of digital medical images and associated information, regardless of the device manufacturer, the American College of Radiology (ACR) and National Electrical Manufacturers Association (NEMA) have developed the Digital Imaging and Communications in Medicine (DICOM) standard for handling, storing, printing, and transmitting information in medical imaging system. DICOM enables the integration of scanners, servers, workstations, printers, and network hardware from multiple manufacturers in a medical imaging system. The standard includes a file format and a network communication protocol. Medical images and patient data in DICOM file format can be exchanged between two devices of the medical system implemented in conformance with DICOM standards. With respect to each of the devices, DICOM conformance statements are made available, which state the DICOM classes they support.

Medical images of a patient captured by the scanner are processed by the devices of the medical imaging system so that the processed medical image can be displayed at a workstation for the clinician to view. Additionally, certain medical systems have post-processing systems to generate additional radiological reports, measurements and images which assist the clinician to detect anatomical abnormalities. Typically, the devices co-ordinate with each other with respect to workflows configured at the respective devices. The tasks of the workflow are performed in a sequential manner. For example, a particular task of the workflow is initiated only if the preceding task of the workflow has been performed.

### SUMMARY OF THE INVENTION

In view of the foregoing, an embodiment herein includes a medical imaging system comprising a first module and a second module for processing the medical image, the first module being operably connected to the second module, and wherein, the first module being configured to provide the medical image to the second module for processing and the second module being configured to provide to the first module an information indicative of a processing status of the medical image using DICOM communication protocols.

In accordance with another aspect of the invention, a method of processing a medical image is provided, wherein the method includes, receiving the medical image to be processed, and providing as an output an information indicative of a processing status of the medical image using DICOM communication protocols.

In accordance with yet another aspect of the invention, a computer program product is provided, where in the computer program product comprises one or more tangible computer readable media, encoded with instructions operative to cause a computer to receive a medical image to be processed, and provide as an output an information indicative of a processing status of the medical image using DICOM communication protocols.

### BRIEF DESCRIPTION OF THE DRAWINGS

The present invention is further described hereinafter with reference to exemplary embodiments shown in the accompanying drawings, in which:

FIG. 1 illustrates a schematic diagram of an exemplary medical imaging system 100 in accordance with an embodiment herein;

FIG. 2 illustrates an exemplary workflow according to an embodiment, wherein a module providing a medical image to another module is configured to request for the status of the processing of the medical image and the module receiving the medical image is configured to provide the status on receiving the request;

FIG. 3 illustrates an exemplary workflow according to an embodiment, wherein a module receiving a medical image for processing is configured to provide a status of processing of the medical image at predefined intervals;

FIG. 4 illustrates an exemplary workflow according to an embodiment, wherein a module receiving an medical image for processing is configured to provide a status of processing of the medical image on an occurrence of an event registered at the module receiving the medical image;

FIG. 5 illustrates a use case to provide examples of how the above-described embodiments can be utilized in the context of a medical imaging system;

FIG. 6 illustrates a second use case to provide examples of how the above-described embodiments can be utilized in the context of a medical imaging system;

FIG. 7 is a flow diagram illustrating a method of processing a medical image in a medical imaging system comprising a plurality of modules, according to an embodiment herein; and

FIG. 8 depicts a representative hardware environment for practicing the embodiments described herein.

### DETAILED DESCRIPTION OF INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

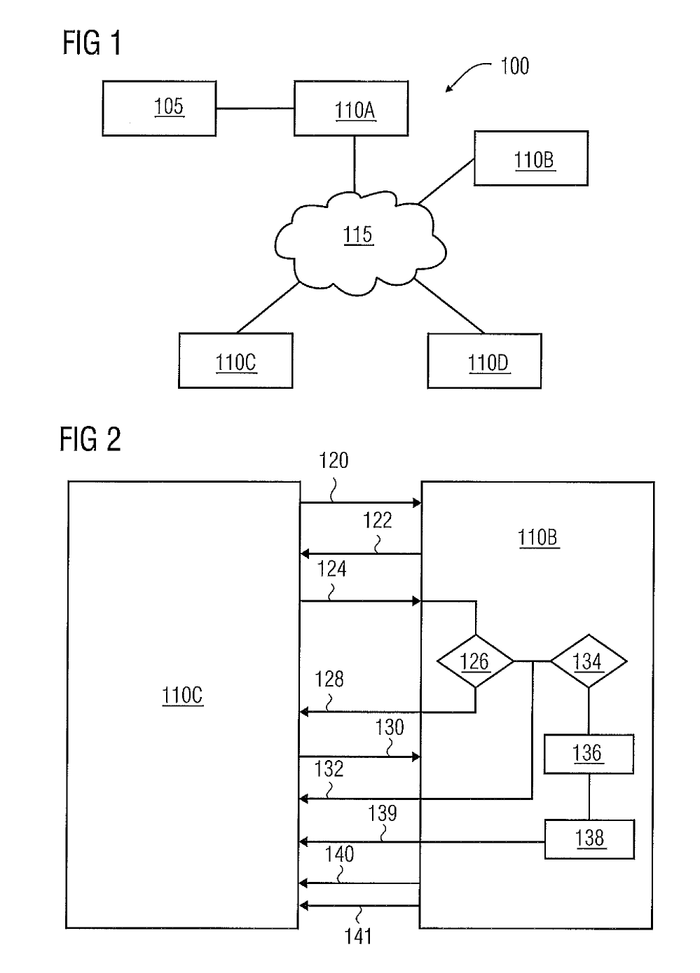

FIG. 1 illustrates a schematic diagram of an exemplary medical imaging system 100 in accordance with an embodiment herein. As illustrated, the medical imaging system 100 comprises a scanner 105 to capture a medical image and a plurality of modules 110 to process the medical image. Processing of the medical image includes, but not limited to, handling, storing, post-processing and displaying of the medical image. Post-processing of the medical image includes, but not limited to, image reconstruction, computer aided detection, three-dimensional view generation, production of radiological reports, and the like. The scanner 105 and the modules 110 are DICOM compliant devices and the medical image is processed in conformance to DICOM standards. In the shown example of FIG. 1, the modules 110 include an acquisition workstation 110A, a post-processing system 110B, a storage system 110C and a viewing workstation 110D. In the shown example of FIG. 1, the system 100 comprising only a single scanner 105, acquisition workstation 110A, a post-processing system 110B, a storage system 110C and a viewing workstation 110D is illustrated for understanding purposes only. In certain implementations, the system 100 may comprise one or more of scanners 105, acquisition workstations 110A, post-processing systems 110B, storage systems 110C and viewing workstations 110D. For example, at a large hospital, the medical imaging system 100 may comprise a plurality of scanners 105, acquisition workstations 110A, and viewing workstations 110D coupled to one or more post-processing systems 110B and storage systems 110C.

The acquisition workstation 110A is coupled to the scanner 105 for acquiring the captured medical image. The acquisition workstation 110A, the post-processing system 110B, the storage system 110C and the viewing workstation 110D are operably connected to a computer network 115 via their respective network interfaces. The network 115 may comprise a local area network (LAN), a metropolitan area network (MAN), a wide area network (WAN) or any network capable of communicating images. The network 115 may be implemented as a wired computer network, or a wireless computer network. In an aspect, the network 115 is DICOM-complaint, and is configured to support the TCP/IP protocol, which is used as the transport protocol for the DICOM standard. The modules 110, i.e., the acquisition workstation 110A, the post-processing system 110B, the storage system 110C and the viewing workstation 110D communicate with each other via the network 115 using DIACOM communication protocols.

As illustrated in the example of FIG. 1, the modules 110C are implemented in separate computer systems, operably connected to the computer network 115 through their respective network interfaces. However, in certain implementations, the modules 110 can be implemented in a single computer system. In case the modules are implemented in a single computer system, the modules can be operably connected directly.

In an aspect, the acquisition workstation 110A handles the medical image after receiving the image from the scanner 105. Typically, in a DICOM compliant system, the images are grouped by topic, such as, patient, study and series to form objects. The acquisition workstation 110A on receiving the raw image data from the scanner 105 populates the attributes for identifying the image including a patient unique identity (UID), a study instance UID, a series instance UID, a service object pair (SOP) class UID, an SOP instance UI, as well as other information that uniquely identify the image, to form instances.

The acquisition workstation 110A can transmit the image to the storage system 110C or the post-processing system 110B. The storage system 110C is used for storing the medical image. As illustrated, the storage system 110C in the present embodiment advantageously comprises a picture achieving and communication system (PACS) application to store the medical image in a DICOM format. The post-processing system 110B can be a computer-aided diagnosis (CAD) system for analyzing the medical image to detect anatomical abnormalities therein. The viewing workstations 110D can be used by a clinician to open, manipulate, and view, the original medical image and the processed medical image. For example, the viewing workstation can be used by the clinician to view the original medical image, and CAD results of the processed medical image. In an aspect, the viewing workstation 110D can superimpose the CAD results over the original medical image offering an opportunity for the clinician in order to facilitate early detection of anatomical abnormalities.

According to an aspect, a module 110 receiving the medical image for processing from another module 110, is configured to provide to the another module 110 providing the medical image, a processing status of the medical image using DICOM communication protocols. For example, in a scenario where the storage system 110C receives the medical image from the acquisition workstation 110A for storing. The storage system 110C on receiving the medical image can be configured to provide information indicating the status of process of storing of the medical image to the acquisition workstation 110A. Similarly, in another scenario the medical image stored at the storage system 110C, can be provided to the post-processing system 110B for post-processing. The post-processing system 110B on receiving the medical image from the storage system 110B can be configured to provide information indicative of the processing status of the medical image to the storage system 110C. The information of the processing status received by the modules 110, i.e., the acquisition workstation 110A and the storage system 110C in the respective aforementioned scenarios, can be used by the modules 110 to further proceed with the next task in the workflow with respect to the image. This eliminates the requirement of user intervention as the user is not required to manually check the status of processing of the medical image to invoke the next task in the workflow in case or error. For example, in accordance with the embodiments described herein, in case of error or the processing takes too long and is not complete, the particular task in the workflow can be initiated by the respective module 110 again.

In an aspect, the module 110 receiving the medical image for processing can be configured to provide the processing status of the medical image periodically at predefined intervals. For example, the module 110 receiving the medical image can be configured to register events. The processing status of the medical image can be provided on the occurrence of the events. The events to be registered can also be provided by the module 110 providing the medical image. In another aspect, the module 110 providing the medical image can be configured to request for the current processing status of the medical image, and the module 110 which has received the medical image for processing can be configured to provide the processing status on receiving the request.

Referring now to FIG. 2, an exemplary workflow is shown according to an embodiment, wherein a module 110 providing the medical image to another module 110 is configured to request for the status of the processing of the medical image and the module 110 receiving the medical image is configured to provide the status on receiving the request. In the shown example of FIG. 2, the workflow is illustrated between a storage system 110C and a post-processing system 110B. However, the workflow illustrated in the example of FIG. 2 can be implemented between any of the modules 110 of FIG. 1. In the shown example of FIG. 1, the storage system 110C is configured to request for the status of the processing of the medical image provided to the post-processing system 110B. The post-processing system 110B is configured to provide the status of the processing of the medical image on receiving the request for the status, using DICOM communication protocols.

As the modules 110 communicate with each other for the status of processing of the medical image using DICOM communication protocols, the modules 110 can be manufacturer independent. For example, in a DICOM complaint medical imaging system, a storage system manufactured by an entity A can query for the status of processing of the medical image to a post-processing system manufactured by an entity B, as the status is being queried using DICOM communication protocols. Similarly, the post-processing system can provide the status of processing of the medical image to the storage system as the same will be provided using DICOM communication protocols.

In the shown example of FIG. 2, the storage system 110C is implemented as a service class user (SCU) and the post-processing system 110B is implemented as a service class provider (SCP). As per DICOM standards, the SCP is referred to a device which provides the services of a DICOM service class or classes to be utilized by another device, referred to as the SCU, and which performs operations and invokes notifications on a specific association. The SCU is referred to a device which utilizes the DICOM service class or classes which are provided by the SCP and which invokes operations and performs notifications on a specific association. The association is a term for a communication context which is used by two application entities that communicate with one another.

Referring still to FIG. 2, the storage system 110C opens an association for communication with the post-processing system 110C, illustrated by the arrow 120. The post-processing system 110C on receiving the association accepts the association, as depicted by the arrow 122. The storage system 110C requests the status of the medical image provided to the post-processing system 110B for processing, designated by the arrow 124. The request may be forwarded as a message containing one or more items. Each item will contain information to uniquely identify the image or a series, such as, study instance UID, series instance UID, SOP class UID, SOP instance UID, and request type. The field request type can be used to specify the type of information requested. For example, in an aspect, the request type can be used to specify that a current status of processing of the medical image is requested. In another aspect, the field request type can be used to specify that a status of processing of the medical image is to be provided on the occurrence of an event. In aspects, where the request type is used to specify the event, the item can comprise a field to specify the type of event, referred herein as event type.

Referring still to FIG. 2, the post-processing system 110B, on receiving the request, designated by the arrow 124, is configured to determine the request type at block 126. In an aspect, if the request type specifies that the information requested is current status of processing of the medical image, the post-processing system 110B provides the information of the current processing status of the medical image, as designated by the arrow 128. In an example, the current processing status of the image can be provided as a percentage of the task completed. The information of the current status including the information to uniquely identify the medical image can be provided as a message. In an aspect, the post-processing system 110B can also provide an estimation of time required for the completion of the processing of the image. The estimation of time can be provided to the storage system 110C with the processing status. On receiving the information on the status of processing of the medical image, the storage system 110C shall close the association, as designated by the arrow 130. In another aspect, if the request type specifies that the status of processing of the medical image is to be provided on the occurrence of an event, then the post-processing system 110B is configured to close the association, designated by the arrow 132. Thereafter, at block 134, the post-processing system 110B, is configured to determine type of event specified by the storage system 110C from the field event type. Once, the type of event is determined, next at block 136, the post-processing system 110B is configured to register the event. Thereafter, at block 138, the post-processing system 110B is configured to determine the occurrence of the event registered at block 136. On the occurrence of the event, the post-processing system 110B is configured to provide to the storage system 110C an information indicating that the event has occurred. The information can be provided by opening an association with the storage system 110C, designated by the arrow 139. The information and the unique identification of the medical image can be provided as a message, designated by the arrow 140. Thereafter, the post-processing system 110B is configured to close the association with the storage system 110B, designated by the arrow 141. In an aspect, an estimation of time required for the completion of the processing of the image medical image can also be provided.

For example, in an aspect, the field event type may specify that intimation is to be provided on the completion of the processing of the medical image. In this case, the post-processing system 110B shall intimate to the storage system 110C that processing of the medical image has been completed. In another aspect, the field event type may specify that intimation is to be provided on completion of a certain percentage of the task. In this case, the post-processing system 110B shall intimate to the storage system 110C that the percentage of the task specified in the event type has been completed.

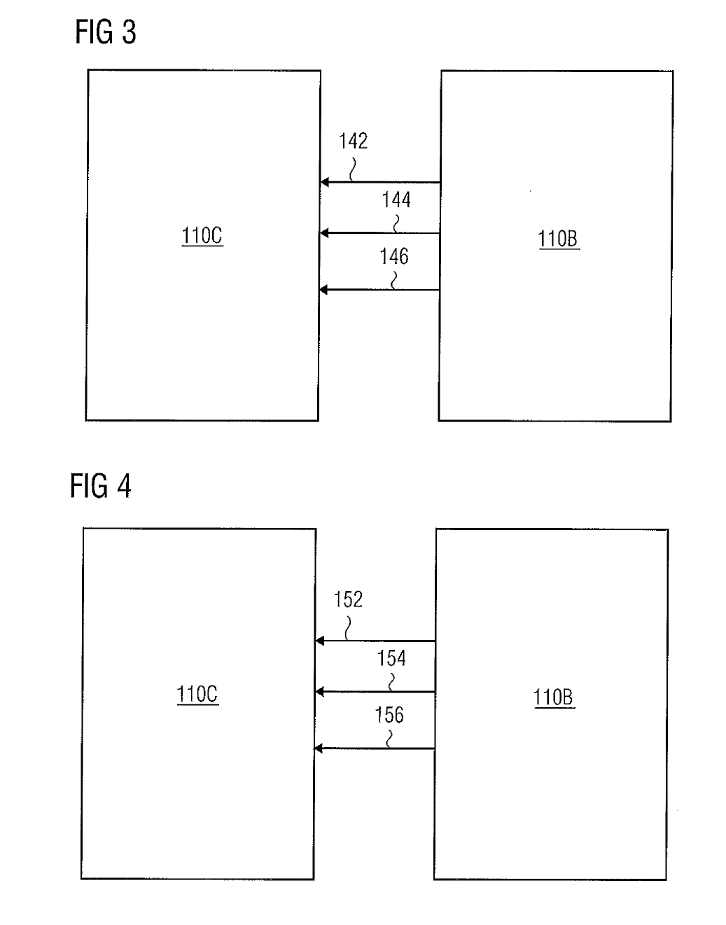

Referring now to FIG. 3, an exemplary workflow is shown according to an embodiment, wherein a module 110 receiving the medical image for processing is configured to provide the status of processing of the medical image at predefined intervals. In the shown example of FIG. 3, the storage system 110C is implemented as a SCU and the post-processing system 110B is implemented as a SCP. In the shown example of FIG. 3, the post-processing system 110B on receiving a medical image from the storage system 110C is configured to provide information on the processing status of the medical image to the storage system 110C at predefined intervals. Thus, at a predefined interval, the post-processing system 110B is configured to open an association for communicating with the storage system 110C, as designated by the arrow 142. Thereafter, the post-processing system 110B is configured to provide the information on the current processing status of the medical image at the predefined interval, designated by the arrow 144. Next, as designated by the arrow 146, the association is closed by the post-processing system 110B. Subsequently, during the next predefined interval, the information on the processing status of the medical image at that time period shall be provided to the storage system 110B in a new association. In the example of FIG. 3, since the information on status is provided in a new association, the message providing the information on the status advantageously may also contain information to uniquely identify the medical image.

Referring now to FIG. 4, an exemplary workflow is shown according to an embodiment, wherein a module 110 receiving the medical image for processing is configured to provide the status of processing of the medical image on an occurrence of an event registered at the module 110 receiving the medical image. In the shown example of FIG. 4, the storage system 110C is implemented as a SCU and the post-processing system 110B is implemented as a SCP. In the shown example of FIG. 4, the post-processing system 110B on receiving a medical image from the storage system 110C is configured to provide information on the processing status of the medical image to the storage system 110C at the occurrence of the event registered at the post-processing system 110B. The event can be pre-registered at the post-processing system 110B Thus, on the occurrence of the event, the post-processing system 110B is configured to open an association for communicating with the storage system 110C, as designated by the arrow 152. Thereafter, the post-processing system 110B is configured to provide the information that the event has occurred to the storage system 110C, designated by the arrow 154. Next, as designated by the arrow 156, the association is closed by the post-processing system 110B.

### Exemplary Use Case 1

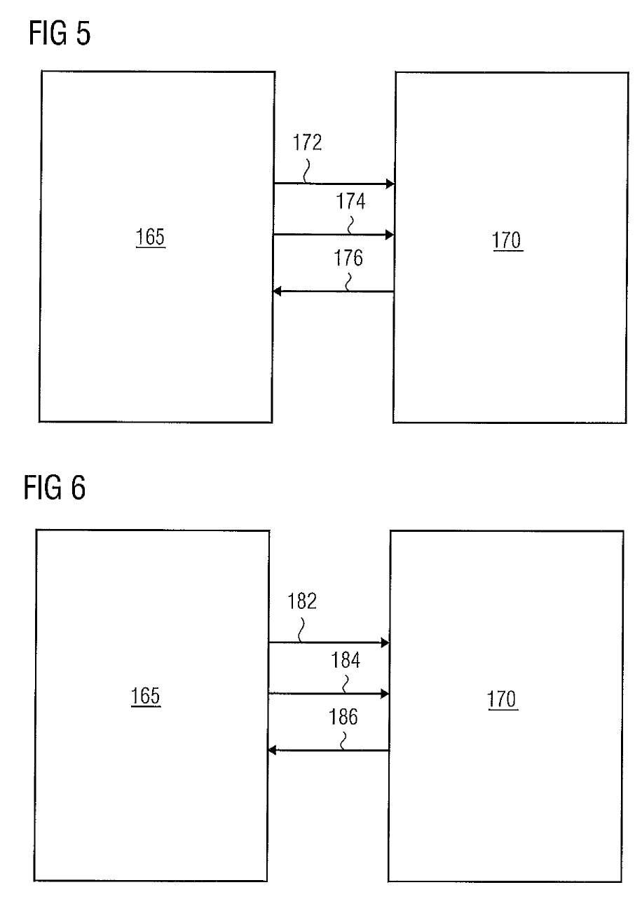

In the shown example of FIG. 5, a use case is illustrated to provide examples of how the above-described embodiments can be utilized in the context of a medical imaging system. As illustrated, a module 110 of FIG. 1 is implemented as an SCU 165 and another module 110 is implemented as an SCP 170. The SCU 165 sends a request to the SCP 170 for storing an image, as designated by the arrow 172. The SCU 165 queries about the status of the job of storing of the image by requesting for the status, designated by the arrow 174. The request for the status of the job is forwarded as a message containing the study instance UID, series instance UID, SOP class UID, SOP instance UID of the image, and a request type. The field request type specifies that a current status of the job of storing of the image is requested. The SCP 170 on receiving the request for the status of storing of the medical image provides the information on the current status of the job of storing the image to the SCU 165, designated by the arrow 176. The information on the status is provided as a message containing the study instance UID, series instance UID, SOP class UID, SOP instance UID of the image, the current status of the job of storing of the image and the estimated completion time of the job. The current status of the job of storing the image is provided to the SCU 165 as the field request type of the message requesting for the status of the job specified that the status is being requested.

### Exemplary Use Case 2

In the shown example of FIG. 6, a second use case is illustrated to provide examples of how the above-described embodiments can be utilized in the context of a medical imaging system. As illustrated, the SCU 165 sends a request to the SCP 170 for storing an image, as designated by the arrow 182. The SCU 165 queries about the status of the job of storing of the image by requesting for the status, designated by the arrow 184. The request for the status of the job is forwarded as a message containing the study instance UID, series instance UID, SOP class UID, SOP instance UID of the image, and a request type. The field request type specifies that the status of the job of storing of the image is to the provided on the occurrence of an event and the field event type specifies on completion of the process of storing the medical image. The SCP 170 determines the type of the event and registers the same. On the completion of the process of storing the medical image, the SCP 170 provides the information that the image has been stored, to the SCU 165, designated by the arrow 186. The information on the completion of the storage is provided as a message containing the study instance UID, series instance UID, SOP class UID and SOP instance UID of the image. The status of the job of storing the image is provided to the SCU 165 on the occurrence of the event, as the field request type of the message requesting for the status of the job specified that the status be provided on the occurrence of an event.

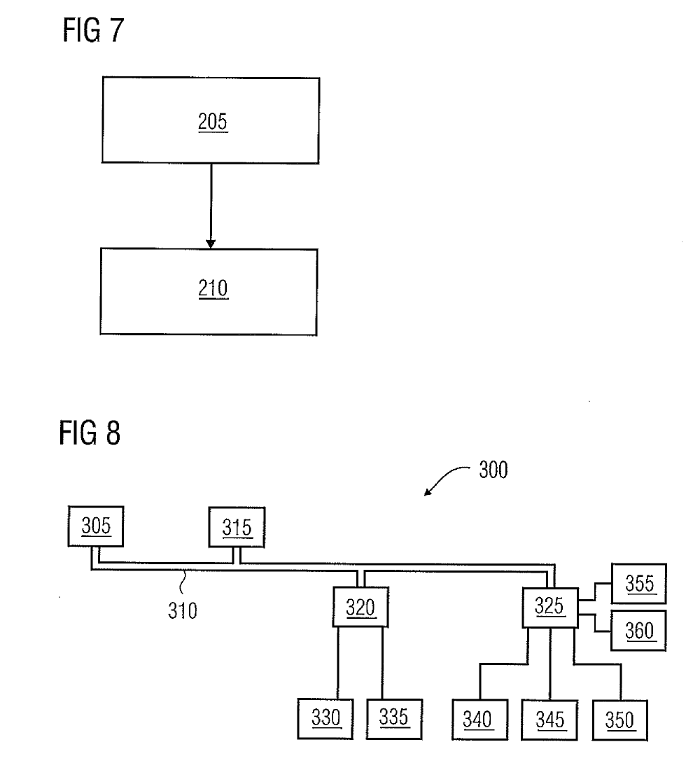

FIG. 7, with reference to FIGS. 1 through 4, is a flow diagram illustrating a method of processing a medical image in a medical imaging system 100 comprising a plurality of modules 110, according to an embodiment herein. At block 205, the medical image to be processed is received via a DICOM-compliant network. Next, at block 210, an information indicative of a processing status of the medical image is provided as an output using DICOM communication protocols.

FIG. 8 depicts a representative hardware environment for practicing the embodiments described herein. This schematic drawing illustrates a hardware configuration of an information handling/computer system 300 in accordance with the embodiments herein. The system 300 comprises at least one processor or central processing unit (CPU) 305. The CPU 305 is interconnected via bus 310 to various devices such as a memory 315, input/output (I/O) controller 320, and user interface controller 325. Depending on the type and configuration of the system 300, the memory 315 may be volatile (such as random access memory (RAM) etc., non-volatile (read only memory (ROM), flash memory devices etc.,) or a combination of the two. The memory 315 is used to store instructions and data for use by the CPU 305. The I/O controller 320 can connect to peripheral devices, such as CD drives 330 and hard drives 335, or other program storage devices that are readable by the system 300. Typically, an operating system for the computer system 300 as well as an application program is stored onto the hard drive 335. The operating system runs on the CPU 305 and is used to coordinate and provide control of various components within system 300. The system 300 can read the inventive instructions on the hard drive 335 and load them onto the memory 315 for execution by the CPU 305. The user interface controller 325 can connect to a keyboard 340, mouse 345, speaker 350, microphone 355, display device 360 and/or other user interface devices such as a touch screen device (not shown) to the bus 310 to gather user input and also to provide system output to the user.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A medical imaging system, comprising:
a first module and a second module for processing a medical image, the first module being operably connected to the second module; and
wherein, the first module being configured to provide the medical image to the second module for processing and the second module being configured to provide to the first module an information indicative of a processing status of the medical image using DICOM communication protocols.

2. The medical imaging system according to claim 1, wherein the first module is configured to send a request for the processing status of the medical image to the second module.

3. The medical imaging system according to claim 1, wherein the first module and the second module are any of an acquisition workstation, a storage system, a post-processing system and a viewing workstation.

4. The medical imaging system according to claim 3, wherein the storage system is a PACS.

5. The medical imaging system according to claim 1, wherein the first module and the second module are part of a single computer system.

6. The medical imaging system according to claim 1, wherein the first module and the second are part of different computer systems, the first module and the second module being operably connected to a computer network through respective network interfaces.

7. The medical imaging system according to claim 1, wherein the processing includes any of handling, storing, post-processing and displaying of the medical image.

8. A method of processing a medical image, the method comprising:
receiving the medical image to be processed; and
providing as an output an information indicative of a processing status of the medical image using DICOM communication protocols.

9. The method according to claim 8, wherein providing as the output the information includes receiving a request for the processing status of the medical image.

10. The method according to claim 9, wherein the request for the processing status includes a request type indicating the type of processing status being requested.

11. The method according to claim 9, wherein the request for the processing status is received during an active association.

12. The method according to claim 9, wherein the request includes an event type specifying a type of event on occurrence of which the processing status is requested.

13. The method according to claim 8, wherein the providing of the information as the output comprises:
registering an event on the occurrence of which the information is to be provided as the output, and
providing the information as the output on the occurrence of the event.

14. The method according to claim 8, wherein the information is provided as the output during the active association.

15. The method according to claim 8, wherein the processing includes any of handling, storing, post-processing and displaying of the medical image.

16. A computer program product comprising one or more tangible computer readable media, encoded with instructions operative to cause a computer to:
receive a medical image to be processed; and
provide as an output an information indicative of a processing status of the medical image using DICOM communication protocols.

17. The computer program product method according to claim 16, wherein providing as the output the information includes receiving a request for the processing status of the medical image.

18. The method according to claim 17, wherein the request includes an event type specifying a type of event on occurrence of which the processing status is requested.

19. The method according to claim 16, wherein the providing of the information as the output comprises:
registering an event on the occurrence of which the information is to be provided as the output; and
providing the information as the output on the occurrence of the event.

20. The method according to claim 16, wherein the processing includes any of handling, storing, post-processing and displaying of the medical image.
